(19) United States
(12) Patent Application Publication
(10) Pub. No.: US 2011/0259179 A1
(43) Pub. Date: Oct. 27, 2011

(54) Method for Recognizing Note Patterns in Pieces of Music

(76) Inventors: Stefan M. Oertl, New York, NY (US); Brigitte Rafael, Wien (AT)

(21) Appl. No.: 13/125,200

(22) PCT Filed: Oct. 15, 2009
(86) PCT No.: PCT/AT09/00401

§ 371 Date: Jul. 8, 2011

(30) Foreign Application Priority Data
Oct. 22, 2008 (EP) 08450164.2

(51) Int. Cl. G10H 1/00

(52) U.S. Cl. 84/609

(57) ABSTRACT

Method for recognizing similarly recurring patterns of notes in a piece of music containing note sequences distributed among parallel channels, the method having the steps of: a) repeatedly segmenting each channel and, for each type of segmentation, determining segments which are similar to one another and storing the latter in lists of candidate patterns with the respective entities thereof; b) calculating an intrinsic similarity value for each list; c) calculating coincidence values for each list for each channel with respect to the lists for all other channels; and d) combining the intrinsic similarity and coincidence values for each list to form a total value for each list, and using the pattern candidates in the lists with the highest total value in each channel as recognized note patterns in the channel.

The present invention relates to a method for recognizing similarly recurring patterns of notes in a piece of music, which contains note sequences distributed on parallel channels.

The recognition of recurring note patterns in pieces of music, e.g. loops, riffs, phrases, motifs, themes, verses, refrains, transitions, movements etc., has become an extensive field of research in recent years with specific and promising technical applications. Some examples of application to be mentioned are the automated analysis of musical structures in pieces of music in computer-aided recording studio, audio workstation and music production environments, which must be based on a reliable music recognition for archiving and sorting purposes as well as the resynthesis of existing note patterns into new compositions. A further specific technical application is the analysis and indexing of large music data banks, e.g. of music archives or online music shops, according to identifiable note patterns for the new field of music information retrieval (MIR), for example, to be able to process “fuzzy” user queries in an automated manner, code word “query by humming”

A wide variety of methods have already been proposed in the past for pattern recognition in single-channel pieces of music that also adopt concepts from other fields of pattern recognition such as “string matching” techniques from the field of DNA sequence analysis, e.g. as in Kilian Jürgen, Hoos Holger H.: “MusicBLAST—Gapped Sequence Alignment for MIR”, International Conference on Music Information Retrieval (ISMIR), 2004. String matching methods are frequently based on the use of dynamic programming algorithms for the alignment and the similarity comparison of note sequences, cf. e.g. Hu Ning, Dannenberg Roger B., Lewis Ann L.: “A Probabilistic Model of Melodic Similarity”, Proceedings of the ICMS, 2002.

In Hsu Jia-Lien, Liu Chih-Chin, Chen Arbee L. P.: “Discovering Nontrivial Repeating Patterns in Musical Data”, IEEE Transactions on Multimedia, vol. 3, no. 3, 2001, the use of a correlation matrix, which allows nontrivial, i.e. not excluding one another, identically recurring patterns in a channel to be detected, is proposed specially for the recognition of identically recurring note patterns for the purposes of music analysis and MIR.

All methods known hitherto have the characteristic that they respectively analyse each channel of a multi-channel piece of music separately. The inventors of the present method have recognized that there is a significant disadvantage in the known methods, because structure information contained specifically in the musical parallelism of the channels, i.e. their rhythmic, melodic and polyphonic context, are completely ignored thereby, and this results in the unsatisfactory rate and quality of recognition of the known methods.

Therefore, there is continuous demand for an improved method of pattern recognition for multi-channel pieces of music. The aim set by the invention is to provide such a method.

This aim is achieved with a method of the aforementioned type that is distinguished by the following steps: a) repeatedly segmenting each channel by varying segment length and segment beginning and, for each type of segmentation, determining segments that are similar to one another and storing these in lists of candidate patterns with their respective instances, i.e. one list respectively for each type of segmentation and channel; b) calculating an intrinsic similarity value for each list, which is based on the similarities of the instances of each candidate pattern of a list with one another; c) calculating coincidence values for each list for each channel with respect to the lists for all other channels, which is respectively based on the overlaps of instances of a candidate pattern of one list with instances of a candidate pattern of the other list when these overlap at least twice; and d) combining the intrinsic similarity and coincidence values for each list to form a total value for each list and using the pattern candidates in the lists with the highest total value in each channel as recognized note patterns in the channel.

The method of the invention thus takes into consideration for the first time and in a significant manner the parallel structure information of a multi-channel piece of music, which can be concealed in the temporal coincidences of potential patterns (candidate patterns) in different channels, and combines these with an assessment of the soundness of discovered candidate patterns on the basis of the intrinsic similarities of their instances, their so-called “fitness”. In consequence, a substantially more reliable, more meaningful and more relevant pattern recognition result is obtained than with all the methods known hitherto.

It should be mentioned at this point that the term “channel” used here for a multi-channel piece of music is to be understood in its most general form, i.e. in the sense of a single voice (monophonic) of a multi-voice (polyphonic) movement, in the sense of a (possibly also polyphonic) instrument voice such as a bass, trumpet, string, percussion, piano part etc., as well as in the sense of a technical channel such as a midi-channel, which can contain both monophonic and polyphonic voices, parts or combinations thereof, e.g. a drum pattern, a chord sequence, a string movement etc.

A particularly advantageous embodiment of the invention is distinguished in that in step a) the following step is additionally conducted:
a1) detecting the patterns identically recurring in a channel, selecting therefrom the patterns best covering the channel and storing these in a further list of candidate patterns with their respective instances for each channel.

The degree of recognition can be still further increased as a result. Channel-related pattern recognition is thus based on two equivalent principles, an identity recognition and a similarity recognition, and different methods can be used for these variants. Incorporating the recognition results of both variants into one and the same list set of candidate patterns results in an implicit combination of the two methods in the subsequent list evaluation by means of the intrinsic similarity and coincidence values, since the results of the two methods are in competition with one another there. The method of the invention is thus self-adaptive for different types of input signals, which respond differently to different types of recognition processes.

In step a1) the detection of identically recurring patterns is preferably conducted by means of the correlation matrix method, as is known per se from Hsu Jia-Lien et al. (as above). It is particularly preferred if in step a1) the selection of the best covering patterns is achieved by iterative selection of the respective most frequent and/or longest pattern from the detected patterns.

According to a further preferred feature of the invention, in step a) the segment length is varied in multiples of the rhythmic unit of the piece of music, which limits the variation possibilities to a suitable degree and saves computing time. It is particularly favourable if the segment length is varied from double the average note duration of the piece of music to half the length of the piece of music.

According to a further advantageous embodiment of the invention, in step a) the determination of segments that are similar to one another is achieved by aligning the notes of two segments with one another, determining a degree of consistency of both segments and recognizing similarity when the degree of consistency exceeds a preset threshold value. These measures can be implemented speedily with a feasible computing effort.

In particular, the alignment of the notes is achieved in this case by means of the dynamic programming method as is known per se from Kilian Jürgen et al. (as above) or Hu Ning et al. (as above with further evidence).

According to a preferred embodiment of the method, the calculation of the intrinsic similarity value in step b) occurs in that for each candidate pattern for the list a similarity matrix of its instances is drawn up, the values of which are combined to form the intrinsic similarity value for the list, preferably with weighting by the channel coverage of the candidate patterns for the list. It has been found that this embodiment leads to a quick and stable implementation.

To further improve the recognition result, at the end of step b) those lists for a channel whose intrinsic similarity value does not reach a preset threshold value can optionally be deleted. This preset threshold value is preferably adaptive, in particular a percentage of the highest intrinsic similarity value of all lists for the channel, particularly preferred at least 70%. In a particularly suitable embodiment in practice the threshold value amounts to about 85%.

A particularly advantageous variant of the method of the invention lies in that in step c) for a specific candidate pattern of a list only the overlaps with those instances of the other list, with which the longest overlaps in time are present, are taken into consideration. It has been found in practical tests that this leads to a satisfactory recognition rate and simplifies the method in this step.

According to a further preferred variant of the invention it is provided that when combining step e) for each list for each channel only those coincidence values to the lists of the other channels that represent the respectively highest value there are taken into consideration, and this improves the recognition rate still further.

For the same reason it is preferably provided that when combining step e) the coincidence values taken into consideration for a list are respectively added up, and it is particularly preferred if the added coincidence values are multiplied by the intrinsic similarity value for the list to form the said total value.

The invention is explained in more detail below on the basis of preferred exemplary embodiments with reference to the accompanying drawings:

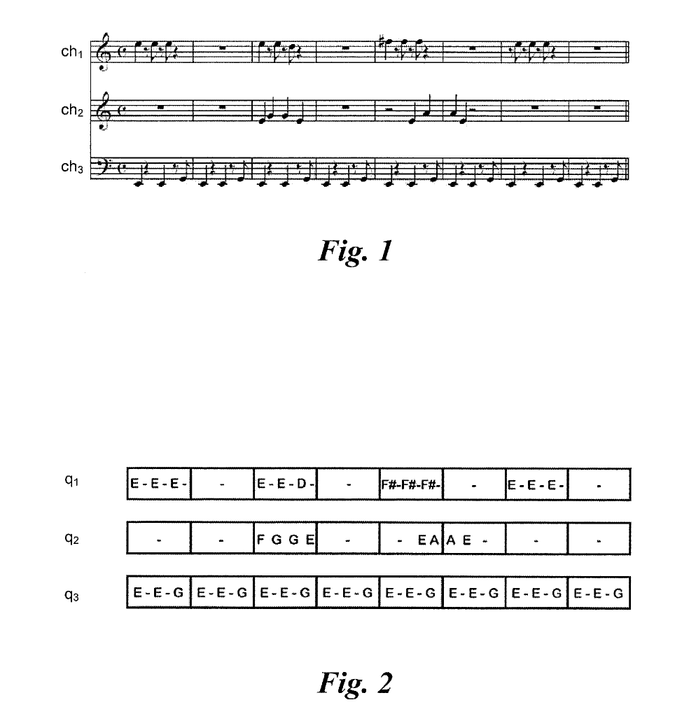

FIGS. 1 and 2 show an exemplary multi-channel piece of music as input signal of the present method in music notation (FIG. 1) and a note sequence diagram (FIG. 2);

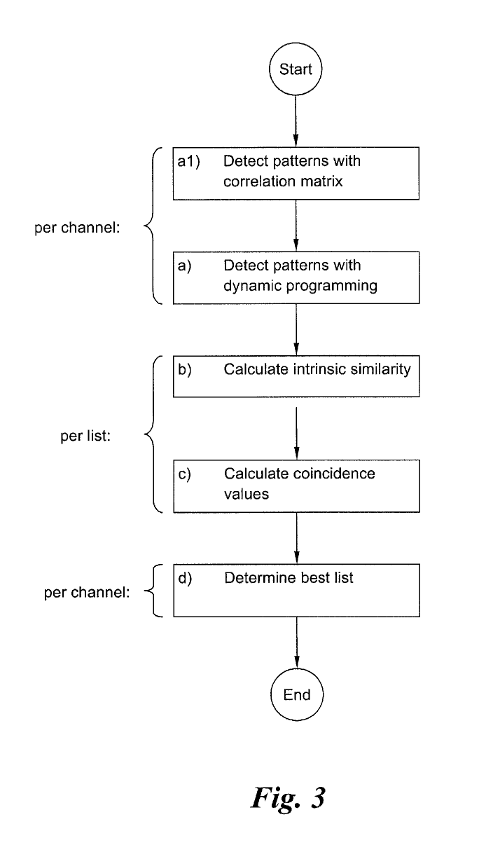

FIG. 3 is a global flow chart of the method according to the invention;

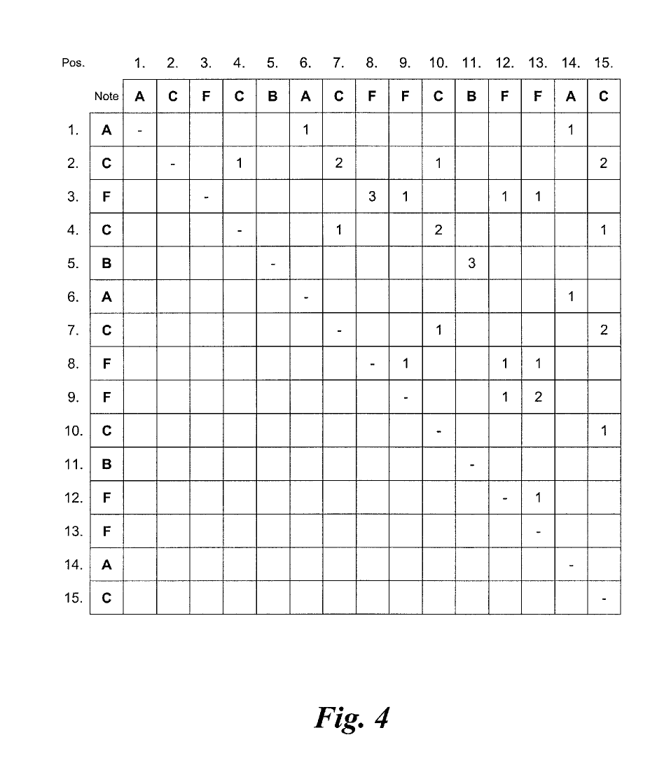

FIG. 4 shows an example of a correlation matrix for step a1) of the method;

FIG. 5 shows the result of the detection phase of step a1);

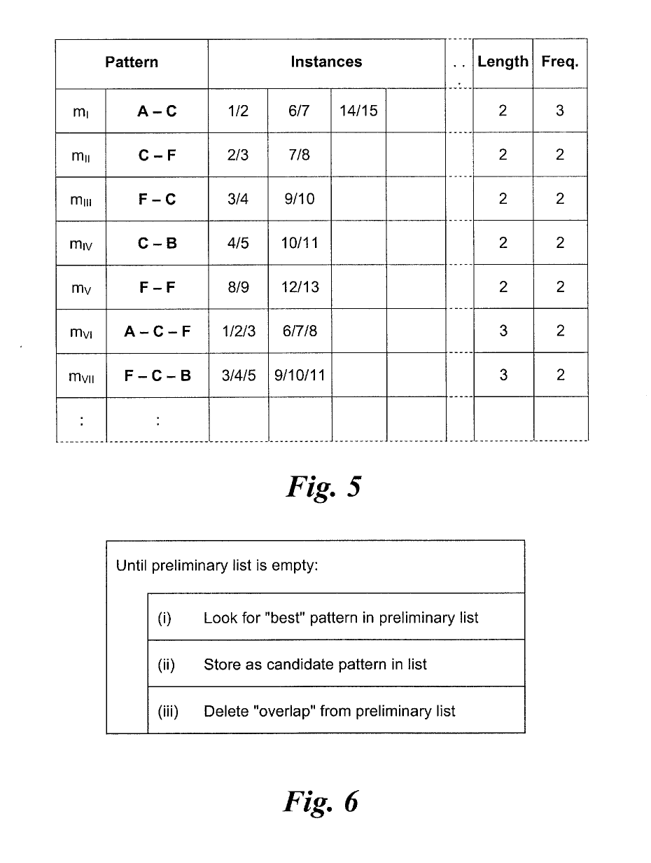

FIG. 6 is a flow chart for the selection phase for the best covering patterns in step a1);

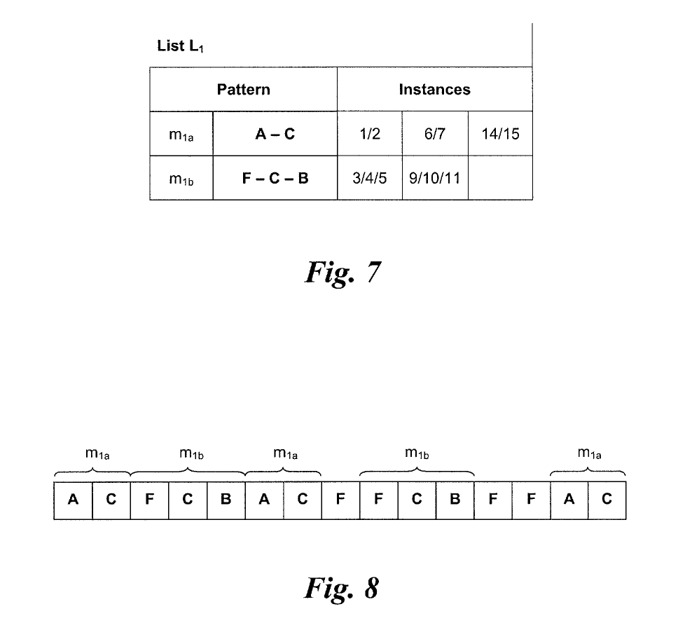

FIG. 7 shows the result of step a1) in the form of a first list of candidate patterns and their instances for a channel;

FIG. 8 shows the significance of the list of FIG. 7 with respect to channel coverage;

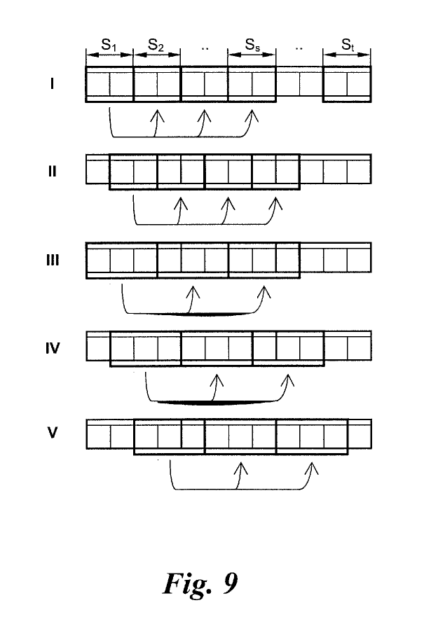

FIG. 9 shows several types of segmentation of a channel for determining the similarity in step a) of the method;

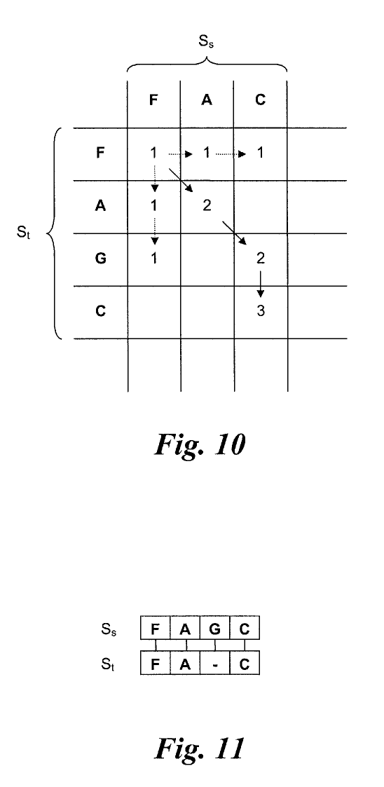

FIG. 10 shows an example of a dynamic programming algorithm for aligning two segments;

FIG. 11 shows the result of the alignment of FIG. 11 for the comparison of similarity of two segments;

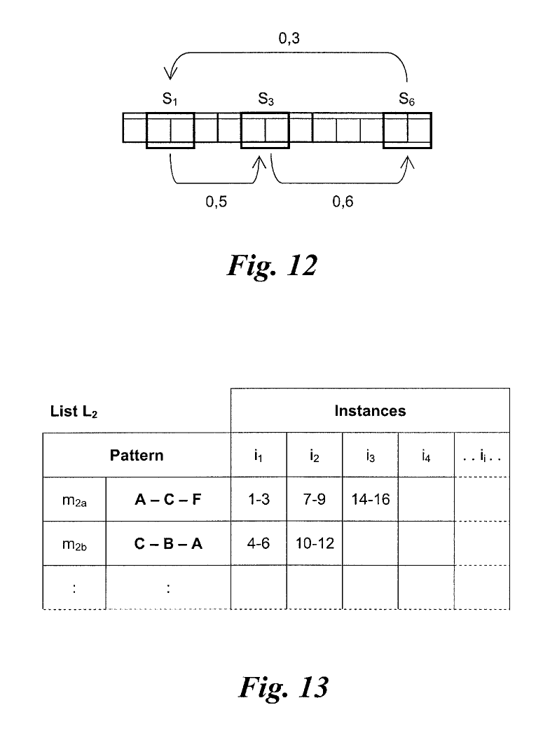

FIG. 12 shows similar and transitively similar segments of a channel, which represent the instances of a recognized candidate pattern;

FIG. 13 shows the result of step a) in the form of a further list of candidate patterns and their instances for a channel and a specific type of segmentation of this channel;

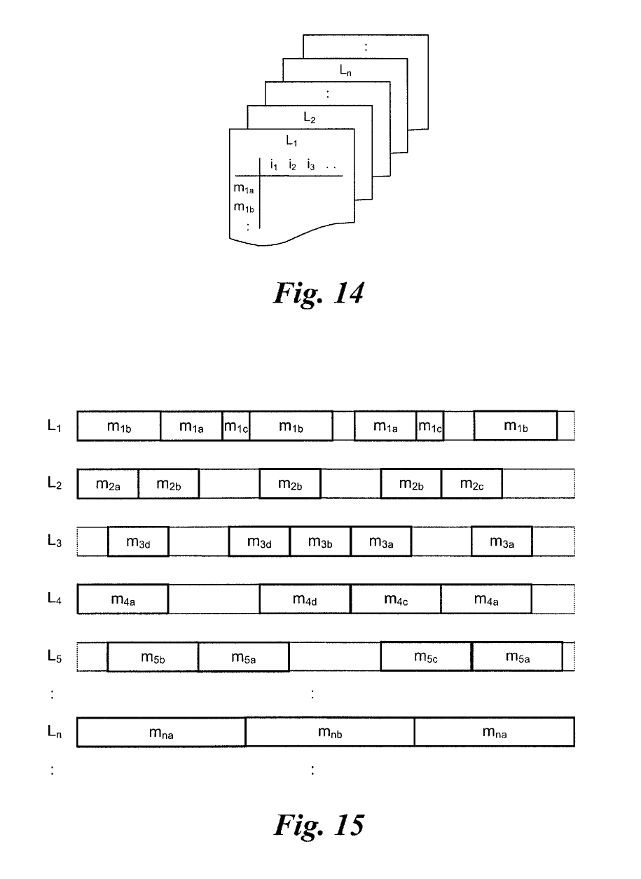

FIG. 14 shows the entire result of step a) represented as a set of multiple lists for a channel;

FIG. 15 shows the significance of the lists of FIG. 14 in the form of different possible coverages of a channel with the respective candidate patterns of its lists;

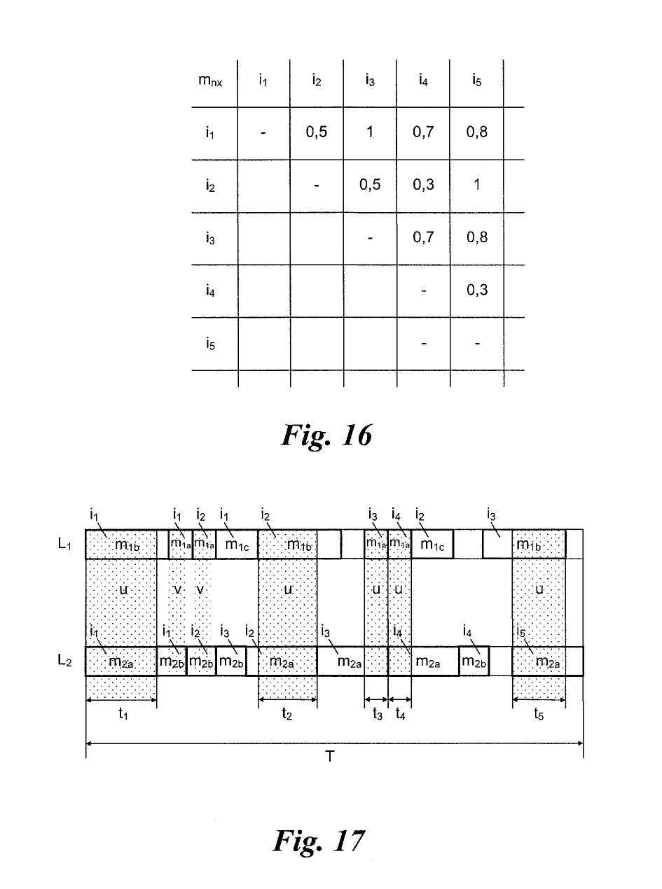

FIG. 16 shows a similarity matrix for the instances of a candidate pattern of a list as basis for the calculation of the intrinsic similarity value of a list according to step b);

FIG. 17 shows an overlap comparison between the pattern instances of two lists as basis for the calculation of the coincidence values of a list according to step c);

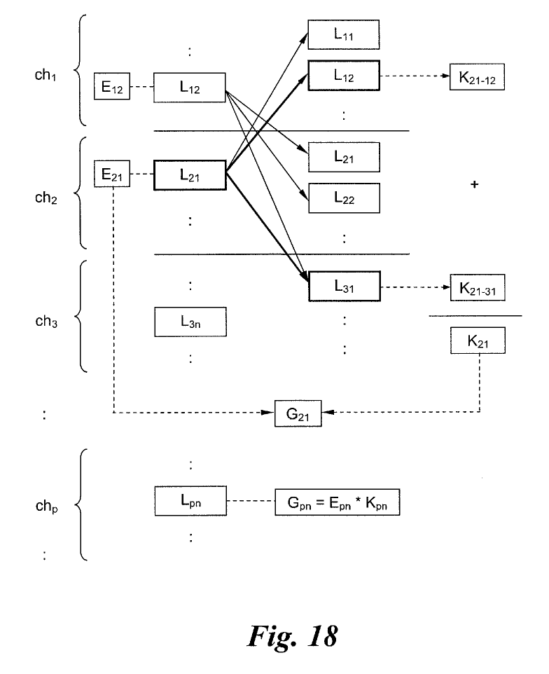

FIG. 18 shows the combination of the intrinsic similarity and coincidence values and the calculation of the total value of a list according to step d); and

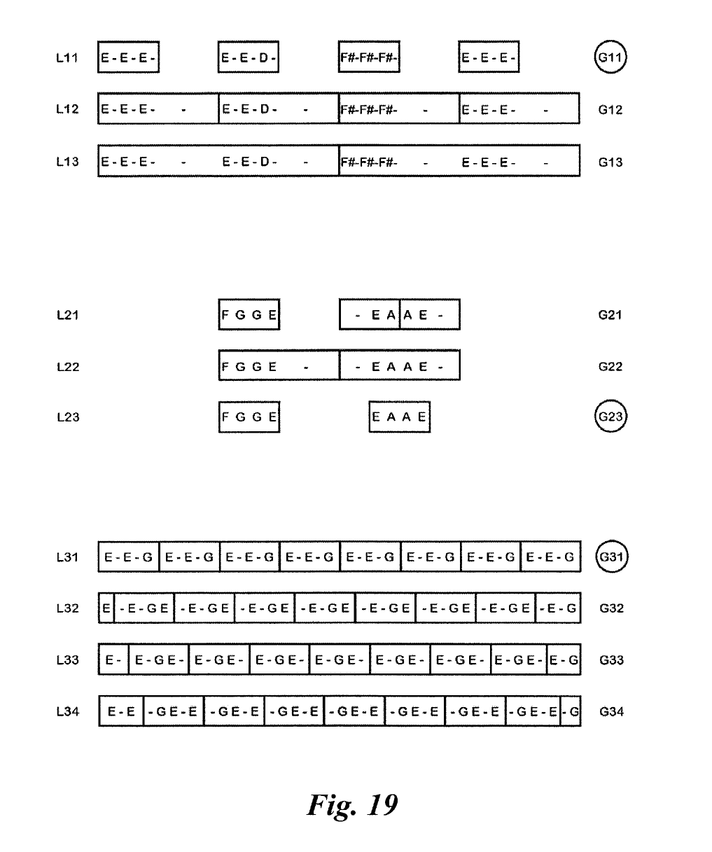

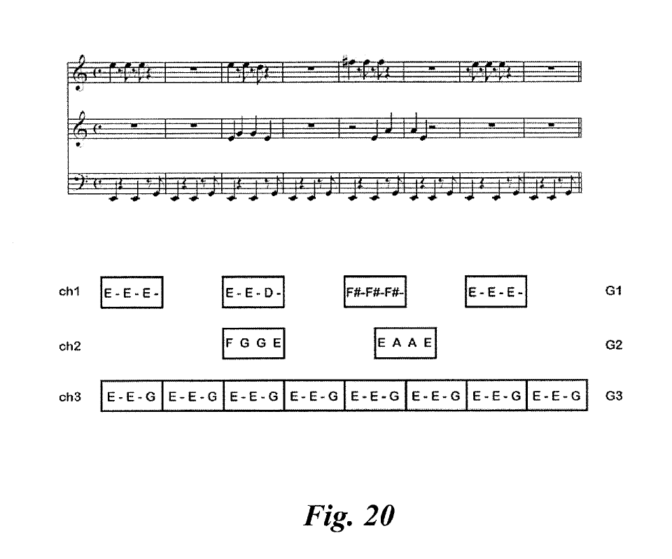

FIGS. 19 and 20 show the result of the application of the method to the input signal of FIGS. 1 and 2 in the form of the possible (FIG. 19) and the best (FIG. 20) channel coverages, the latter of which represent the note patterns recognized in the channels.

FIG. 1 shows a section from a piece of music containing note sequences q₁, q₂ and q₃ (in general qₚ) distributed on parallel channels ch₁, ch₂ and ch₃ (in general chₚ) and shown schematically in FIG. 2. The channels chₚ are, for example, separate MIDI channels for the different instruments or voices of the piece of music, although this is not essential, as explained above.

In the interests of simplicity, only the note pitches and the times of incidence of the individual notes in the note sequences qₚ are taken into consideration in the present examples, but not further note parameters such as e.g. note duration, loudness, striking speed, envelope, tone, key context, etc. However, it is understood that all comparisons of individual notes or note patterns described below can also extend equally to such parameters, if desired, i.e. multistage or multi-dimensional identity or similarity comparisons between multiple parameters can also be conducted accordingly in these comparisons.

Moreover, in the interests of simplicity also only monophonic note sequences are considered in each channel in the present examples. However, it is understood that the method proposed here is equally suited to polyphonic note sequences in the channels, for which extended identity or similarity comparisons, e.g. chord comparisons and key context comparisons etc., can be employed accordingly.

As is thus evident for the person skilled in the art, the method proposed here can be easily scaled to multiple note parameter comparisons and polyphonic note sequences.

FIG. 3 shows the global sequence of the method on the basis of its five fundamental steps a1), a), b), c) and d), which shall be explained in detail below. These five global steps are: a1) detecting the patterns identically recurring in a channel, selecting therefrom the patterns best covering the channel and storing these in a list of candidate patterns with their respective instances for each channel; a) repeatedly segmenting each channel by varying segment length and beginning, and for each type of segmentation determining segments that are similar to one another and storing these in further lists of candidate patterns with their respective instances, i.e. one list respectively for each type of segmentation and channel; b) calculating an intrinsic similarity value for each list, which is based on the similarities of the instances of each candidate pattern of a list with one another; c) calculating coincidence values for each list for each channel with respect to the lists for all other channels, which is respectively based on the overlaps of instances of a candidate pattern of one list with instances of a candidate pattern of the other list when these overlap at least twice; and d) combining the intrinsic similarity and coincidence values for each list to form a total value for each list and using the pattern candidates in the lists with the highest total value in each channel as recognized note patterns in the channel.

The represented sequence of steps a1)-a)-b)-c)-d) is only essential insofar as some steps assume the result of others. Otherwise, the sequence is arbitrary. For example, the sequence of steps a1) and a) could be interchanged, or the sequence of steps b) and c), and so on.

In a simplified embodiment of the method step a1) can optionally be omitted with the range of application of the method limited accordingly, as explained above.

Steps a1) to d) will now be explained in detail.

a1) Pattern Detection by Means of Correlation Matrix

To detect the identically recurring note patterns (identical “loops”) in a channel chₚ a correlation matrix is firstly drawn up for each channel chₚ in accordance with Hsu Jia-Lien et al. (as above) in step a1). FIG. 4 shows an example of such a correlation matrix: the first line and the first column respectively contain the entire note sequence of a channel, in which patterns are to be detected; and only a triangle of the matrix is relevant. The first entry “1” in a line means that a note in the sequence is already appearing for the second time; and entry “2” means that the pattern consisting of this and the previous note with length 2 (“2-loop”) is appearing for the second time; the entry “3” that the pattern consisting of this and the previous note with length 3 (“3-loop”) is appearing for the second time in this line, etc. Reference is made to Hsu Jia-Lien et al. (as above) for details of the correlation matrix method.

Through statistical evaluation of the entries in the correlation matrix FIG. 4 a preliminary list can be drawn up for each channel in accordance with FIG. 5, in which note patterns m_{I}, m_{II}, m_{III}, m_{IV} etc. found to be identically recurring are specified with the positions in which they occur or appear in the note sequence qₚ, i.e. their so-called “instances”, as well as their length and frequency.

From the preliminary list of FIG. 5 those note patterns that cover channel chₚ as far as possible and also without overlap are now sought for further processing using the search method outlined in FIG. 6. For this, the preliminary list FIG. 5 is processed in a loop according to FIG. 6 and in each case (i) the “best” pattern m_{I}, m_{II} etc. is looked for, (ii) this is stored as candidate pattern m₁ₐ, m₂ₐ etc. in a first list L₁ (FIG. 7) together with its instances, and (iii) all patterns overlapping with this candidate pattern are deleted from the preliminary list FIG. 5.

The “best” pattern in step (i) is respectively the most frequent and/or longest pattern m_{I}, m_{II} etc. in the preliminary list FIG. 5. It is particularly preferred if the following criterion for the “best” pattern is used:
The most frequent pattern is selected unless there is a longer candidate pattern that covers more than 75% of the channel and occurs at last ⅔ as often.

Therefore, the result obtained from step a1) for each channel chₚ is a first list L₁ of candidate patterns m₁ₐ, m_{1b} (in general m₁ₓ), which cover the channel chₚ or its note sequence qₚ without overlap and as far as possible, i.e. as gap-free as possible, see FIG. 8.

### a) Pattern Detection by Means of Segment Similarity Comparison

A second approach is followed in step a). Each channel chₚ is segmented repeatedly and respectively in different ways, i.e. by varying segment length and beginning. FIG. 9 shows five exemplary types of segmentation I-V, wherein the segment length is varied in multiples of the rhythmic unit of the piece of music, i.e. the duration of a beat of the piece of music; e.g. in 4/4 time the rhythmic unit is a crotchet (quarter note).

The shown types of segmentation I and II are based on a segmentation into segments with a length of two beats, wherein in segmentation II the segment beginning has been displaced by one beat.

The types of segmentation III—V are based on a segment length of three beats and a successive displacement of the segment beginning by one beat in each case.

It is understood that this concept can be extended accordingly to any desired segmentation lengths, beginnings and also to any desired fine quantisation units (beats) of the note sequences.

In this case, the segment length of double the average note duration of the piece of music is preferably varied to half the length of the entire piece of music at maximum, since the maximum length of a note pattern can be half the length of the piece of music at most. If desired, the process could also be stopped earlier to shorten it, i.e. segment length could be varied only to a given number of pulses, for example.

For each possible type of segmentation I, II, III etc. the similarity of the segments S₁, S₂, etc. with one another is now determined, i.e. preferably using the dynamic programming method known in the art.

To explain this method, reference is now made only briefly to FIG. 10, in which note sequences from two exemplary segments Sₛ and Sₜ are compared to one another in a matrix. According to the rules of the dynamic programming algorithm, weightings are now given for the progression from cell to cell, i.e. in the present example the dynamic programming weightings {0, 0, 0, 1} are given as {“penalty for insert”, “penalty for delete”, “penalty for replace”, “points for match”}. Reference is made here to Kilian Jürgen et al. (as above) and Hu Ning et al. (as above) for details of the dynamic programming method, which also contain further literature references thereto.

Using the dynamic programming alignment method of FIG. 10 even non-identical i.e. merely similar note sequences and even those of unequal length in the segments are aligned to one another. FIG. 11 shows the alignment result obtained.

The similarity of segments Sₛ and Sₜ is then evaluated by means of an accordingly selected point evaluation chart between 0% (dissimilar) and 100% (identical), e.g. on the basis of the number of identical notes, the number of gaps, the pitch interval of deviating notes etc. Two segments Sₛ, Sₜ are then recognized as “similar” when their similarity value determined in such a manner lies above a preset threshold value, preferably above 50%.

In this way, all segments Sₛ are now compared with all other segments Sₜ of a type of segmentation I, II etc. of a channel chₚ. For segmentation type II of channel chₚ, for example, this leads to recognition of a similarity between the segments S₁, S₃ and S₆, as shown in FIG. 12: segments S₁ and S₃ here are 50% similar, segments S₃ and S₆ are 60% similar and segments S₁ and S₆ are 40% “transitively similar”.

All segments that are similar to one another or also only transitively similar are now compiled again as instances iᵢ of a candidate pattern, which results from the note sequence of one (e.g. the first) of these segments. The candidate patterns found for a segmentation type of a channel in this way are stored in the form of a further list L₂ of candidate patterns m₂ₐ, m_{2b} etc. with their respective instances i₁, i₂ etc., see FIG. 13.

All lists L₂, L₃ etc. for all possible segmentation types I, II etc. of a channel chₚ together with the previously discussed first list L₁ from step a1) provide a set of lists Lₙ for each channel chₚ, see FIG. 14, which represents various possible coverages of the channel chₚ with candidate patterns, see FIG. 15.

The lists Lₙ are now evaluated in the following steps b), c) and d).

### b) Calculation of the Intrinsic Similarity Values

In step b) an intrinsic similarity value Eₙ is firstly calculated for each list L₁, on the basis of similarity matrices for all candidate patterns mₙₐ, m_{nb} etc. (in general mₙₓ) for list Lₙ. FIG. 16 shows an exemplary similarity matrix for the instances i₁, i₂, i₃ and i₄ of a candidate pattern mₙ for list Lₙ: the cells of the matrix reflect the degree of similarity, e.g. as determined in accordance with the dynamic programming step of step a); e.g. the similarity between instance i₁ and instance i₃ here amounts to 80%.

An intrinsic similarity value Eₙₓ for the candidate pattern mₙₓ is now determined from all values of the similarity matrix FIG. 16, e.g. by adding in the form:

$${E}_{nx} = {\sum }_{k , l} similarity between {i}_{k} and {i}_{l}$$

Alternatively, an evaluation chart can also be used that statistically evaluates or assesses the values in the cells of the similarity matrix, preferably in the following form:
if at least one cell per line has the entry “1”, then Eₙₓ is incremented by 2, i.e.

Eₙₓ:=Eₙₓ+2;
if not then Eₙₓ is only incremented by the average value of all cells of this line, i.e.

Eₙₓ:=Eₙₓ+line average.

The intrinsic similarity value Eₙₓ of the candidate pattern mₙₓ is also called “loop fitness” of the candidate pattern mₙₓ.

The intrinsic similarity value Eₙ of list Lₙ then results as a sum of the intrinsic similarity values Eₙₓ of all candidate patters mₙₓ of list Lₙ multiplied by the channel coverage P, which all instances of all candidate patterns mₙₓ of list Lₙ reach, i.e.

$${E}_{n} = {\sum }_{x} {E}_{nx} * {P}_{n} .$$

Channel coverage Pₙ of a list Lₙ of a channel chₚ is understood to mean either the temporal coverage of the channel as sum of the time durations tₙₓᵢ of all instances i of all candidate patterns mₙₓ of the channel, in relation to the total duration Tₚ of the channel chₚ; or the note-related coverage of the channel as sum of the numbers of notes nₙₓᵢ in all instances i of all candidate patters mₙₓ of the channel, in relation to the total number Nₚ of notes of the channel chₚ; or preferably both the temporal and the note-related coverage in weighted form, e.g. equally weighted, i.e.

$${P}_{n} = \frac{1}{2} ( \frac{{\sum }_{x , i} {t}_{nxi}}{{T}_{p}} + \frac{{\sum }_{x , i} {n}_{nxi}}{{N}_{p}} )$$

In an optional step, after determination of the intrinsic similarity values Eₙ of the lists Lₙ, e.g. directly after step b), for a specific channel chₚ all those lists Lₙ of the channel chₚ having intrinsic similarity values Eₙ that do not reach a preset threshold value can be deleted. The threshold value can preferably be predetermined adaptively or dynamically, e.g. as a percentage of the highest intrinsic similarity value Eₙ of all lists Lₙ of the channel chₚ, e.g. at least 70% or particularly preferred about 85% of the highest intrinsic similarity value Eₙ of all lists Lₙ of the channel chₚ.

### c) Calculation of the Coincidence Values

In step c) coincidence values are calculated for each list Lₙ, i.e. between each list Lₙ of every channel chₚ and each list Lₙ of every other channel chₚ, as outlined in FIGS. 17 and 18.

FIG. 18 shows—as representative of all these coincidence value calculations—the first list L₂₁ of the channel ch₂, which is respectively compared with all other lists (but not with the lists of its own channel ch₂) in order to respectively calculate coincidence values K₂₁₋₁₂, K₂₁₋₃₁ etc., in general K_{pn-p′n′} (with p′≠p), from which a total coincidence value Kₚₙ is then determined for each list Lₚₙ, as will be described further below.

According to FIG. 17 a coincidence value is calculated from the temporal overlaps u of the instances iᵢ of two lists to be compared with one another—for simplicity only indicated as L₁ and L₂ in FIG. 17—: the coincidence value K_{pn-′n′} is the sum of all timedurations tᵢ of all those instance overlaps u that are taken into consideration as below in relation to the time duration T of the entire channel chₚ considered.

In this case only those overlaps u of instances iᵢ of a candidate pattern m₁ₓ of list L₁ with instances iᵢ of the candidate pattern m₂ₓ of list L₂ that occur at least twice are considered, and only those overlaps u that generate the longest—candidate pattern-related—overlap times tᵢ. In the example of FIG. 17 this means: the candidate pattern m_{1b} (i.e. its three instances i₁, i₂, i₃) overlaps three times with instances of one and the same candidate pattern of the second list L₂, i.e. with three instances i₁, i₂ and i₅ of the candidate pattern m₂ₐ at overlap times t₁, t₂ and t₅; and only these overlap times are taken into consideration for the candidate pattern m_{1b}.

All further overlaps of the candidate pattern m_{1b} with instances of other candidate patterns, e.g. instances i₁ and i₄ of m_{2b}, remain unconsidered, since these overlaps are shorter than the aforementioned. The repeated overlap of instance i₂ of m_{1b} with instance i₃ of m₂ₐ is not counted, but respectively only one double overlap per instance of the first list L₁, i.e. the longest in time.

Repeated overlaps v of instances i₁ and i₂ of the candidate pattern m₁ₐ with instances i₁ and i₂ of the candidate pattern m_{2b} likewise remain unconsidered, since the overlaps u of instances i₃ and i₄ of m₁ₐ with instances i₁ and of m₂ₐ were taken into consideration.

The coincidence value K_{pn-p′n′} can optionally be increased for instances coinciding exactly in its beginning or end—in the shown example of FIG. 17 the coincident beginnings of the first instances i₁ of the candidate patterns m_{1b} and m₂ₐ as well as the coincidences i₁ of the candidate patterns m_{1b} and m₂ₐ as well as the coincidence of the ends of the third instances i₃ of m₁ₐ and m₂ₐ or the beginnings of the fourth instances i₄ of m₁ₐ and m₂ₐ—for each coincidence in particular, e.g. incremented by a given “bonus value”.

Coming back to the general method of reference in FIG. 18, there thus results for the list Lₚₙ of channel chₚ the coincidence values K_{pn-p′n′} in relation to the lists of all other channels:

$${K}_{pn - {p}^{′} {n}^{′}} = \frac{{\sum }_{i} {t}_{pn , i}}{{T}_{p}} with {T}_{p} = {T}_{{p}^{′}}$$

### d) Combination of the Intrinsic Similarity and Coincidence Values

The intrinsic similarity values Eₚₙ and coincidence values K_{pn-p′n′} determined for each list Lₚₙ are combined to form a total value Gₚₙ of list Lₚₙ, e.g. by addition, multiplication or other mathematical operations.

The following combination is applied: as illustrated in FIG. 18, for a list, e.g. the first list L₂₁ of the second channel ch₂, only those coincidence values K_{21-p′n′} in relation to lists L_{p′n′} of the other channels ch_{p′}, which respectively have the highest value there in each channel, are taken into consideration. In the shown example this relates to the coincidence value K₂₁₋₁₂ for the second list L₁₂ of the first channel ch₁ and the coincidence value K₂₁₋₃₁ to the first list L₃₁ of the third channel ch₃.

These channel-maximum coincidence values are added to a total coincidence value Kₚₙ for the list Lₚₙ, i.e.:

$${K}_{pn} = {\sum }_{{p}^{′}} {max}_{in {p}^{′}} ( {K}_{pn - {p}^{′} {n}^{′}} ) .$$

The total coincidence value Kₚₙ of the list Lₚₙ is then multiplied by the intrinsic similarity value Eₚₙ of the list Lₚₙ to give a total value Gₚₙ for the list Lₚₙ:

Gₚₙ=Eₚₙ*Kₚₙ

Then the respective list Lₚ that has the highest total value Gₚ is sought in each channel chₚ

$${G}_{p} = {max}_{in p} ( {G}_{pn} )$$

In the example shown in FIG. 19, which is based on the input sequences of FIGS. 1 and 2, these are list L₁₂ as result list L₁ of the first channel ch₁, list L₂₁ as result list L₂ of the second channel ch₂ and list L₃₃ as result list L₃ of the third channel chᵢ.

The candidate patterns mₚₓ of list Lₚ thus constitute the respectively best known similarly recurring note patterns of the channel—i.e. with consideration of its structure relations to all other channels—as shown in FIG. 20.

The invention is not restricted to the represented embodiments, but covers all variants and modifications that fall within the framework of the attached claims.

What is claimed is:

1. Method for recognizing similarly recurring patterns of notes in a piece of music, which contains note sequences distributed on parallel channels comprising the steps of:
a) repeatedly segmenting each channel by varying segment length and segment beginning and, for each type of segmentation, determining segments that are similar to one another and storing these in lists of candidate patterns with their respective instances, i.e. one list respectively for each type of segmentation and channel;
b) calculating an intrinsic similarity value for each list, which is based on the similarities of the instances of each candidate pattern of a list with one another;
c) calculating coincidence values for each list for each channel with respect to the lists for all other channels, which is respectively based on the overlaps of instances of a candidate pattern of one list with instances of a candidate pattern of the other list when these overlap at least twice; and
d) combining the intrinsic similarity and coincidence values for each list to form a total value for each list and using the pattern candidates in the lists with the highest total value in each channel as recognized note patterns in the channel.

2. Method according to claim 1, wherein in step a) the following step is additionally conducted: a1) detecting the patterns identically recurring in a channel, selecting therefrom the patterns best covering the channel and storing these in a further list of candidate patterns with their respective instances for each channel.

3. Method according to claim 2, wherein in step a1) the detection of identically recurring patterns is conducted by means of the correlation matrix method known per se.

4. Method according to claim 2, wherein in step a1) the selection of the best covering patterns is achieved by iterative selection of the respective most frequent and/or longest pattern from the detected patterns.

5. Method according to claim 1, wherein in step a) the segment length is varied in multiples of the rhythmic unit of the piece of music.

6. Method according to claim 5, wherein the segment length is varied from double the average note duration of the piece of music to half the length of the piece of music.

7. Method according to claim 1, wherein in step a) the determination of segments that are similar to one another is achieved by aligning the notes of two segments with one another, determining a degree of consistency of both segments and recognizing similarity when the degree of consistency exceeds a preset threshold value.

8. Method according to claim 7, wherein the alignment of the notes is achieved by means of the dynamic programming method known per se.

9. Method according to claim 1, wherein in step b) for each candidate pattern for the list a similarity matrix of its instances (i) is drawn up, the values of which are combined to form the intrinsic similarity value for the list, preferably with weighting by the channel coverage of the candidate patterns for the list.

10. Method according to claim 1, wherein at the end of step b) those lists for a channel whose intrinsic similarity value do not reach a preset threshold value are deleted.

11. Method according to claim 10, wherein the preset threshold value is a percentage of the highest intrinsic similarity value of all lists for the channel, preferably at least 70%, particularly preferred about 85%.

12. Method according to claim 1, wherein in step c) for a specific candidate pattern of a list only the overlaps with those instances of the other list, with which the longest overlaps in time are present, are taken into consideration.

13. Method according to claim 1, wherein in combining step d) for each list for each channel only those coincidence values to the lists of the other channels that represent the respectively highest value are taken into consideration.

14. Method according to claim 1, wherein in combining step d) the coincidence values taken into consideration for a list are respectively added up.

15. Method according to claim 14, wherein in combining step d) the added coincidence values are multiplied by the intrinsic similarity value for the list to form the said total value.
